(19) United States
(12) Patent Application Publication
(10) Pub. No.: US 2011/0117331 A1
(43) Pub. Date: May 19, 2011

(54) METHOD FOR MANUFACTURING AN OPTICAL FILM

(76) Inventor: Henrik Bang Mikkelsen, Herfolge (DK)

(21) Appl. No.: 12/936,007

(22) PCT Filed: Apr. 3, 2008
(86) PCT No.: PCT/DK2008/050081

§ 371 Date: Jan. 21, 2011

(51) Int. Cl. B32B 3/10; B05D 5/06; C08F 2/48

(52) U.S. Cl. 428/195.1; 427/162; 427/510

(57) ABSTRACT

A method for manufacturing an optical film (1) is disclosed. The method comprises the step of providing a continuous sheet of transparent plastic material (2). One side of said sheet of transparent plastic material (2) is coated with a layer of curable transparent resin. The coating of curable transparent resin coating is embossed using an embossing roller (5) having a surface, with a predetermined surface structure, so as to provide a desired optical structure in said curable transparent resin. The curable transparent resin is cured, while the curable transparent resin is in contact with said embossing roller (5), so as to harden said desired optical structure.

The present invention relates to a method for manufacturing an optical film, more specifically an optical film having a surface presenting optical elements, in particular prismatic lenses.

It is well known to provide optical elements, such as prismatic or lenticular lenses, in the surfaces of sheets of transparent material. This allows the control of light transmitted through or reflected by the sheet. By the provision of prismatic lenses in the surface, light transmitted through the sheet may be refracted in a controlled manner, to e.g. focus it, spread it, divert it laterally or scatter it. If the prismatic lenses are of a generally high quality, the control of the light emanating from the optical film will be good.

Thus, in the English language abstract of KR-A-1020050005287 there is disclosed a method according to the opening paragraph for making a fine pattern in an optical film. According to KR-A-1020050005287 an optical film is sequentially supplied from a film supply roll. A UV resin is coated on one surface of the supplied optical film through a coater. The UV resin on the optical film is first hardened by making it pass through a dryer. A fine pattern is then formed in the optical film by making the dried optical film pass through an embossing roll of a hot-embossing unit. The optical film with the fine pattern is subsequently hardened by irradiation with UV light.

One of the critical points in the quality of such prismatic lenses is the sharpness of the protruding tips of the prismatic lenses and of the bottoms of the valleys between two adjacent prismatic lenses. The surfaces of the prisms must have well defined angles with respect to the plane of the sheet, so as to refract or reflect the light in the desired direction, the latter by total internal reflection or TIR for short. However, if the tips or the bottoms are not sharp, but rounded, the desired angles of the surfaces are not given in these areas. This in turn gives rise to light emanating in a direction not corresponding to the one desired. The larger the radius of these rounded areas, the more light is lost in undesired directions. Not only is this light wasted but also undesired patterns may arise. If e.g. the purpose is to diffuse light, the surface should have a uniform translucent appearance, without optical artefacts such as moiré, rings, fringe patterns, etc. If, on the other hand, all light is to be refracted in a desired direction or focussed, light should not be wasted by emanating in an undesired direction from the vicinity of the tips and bottoms.

Based on this, it is the object of the present invention to provide an optical film having surface structures with a very small radius of curvature.

According to the present invention, this is achieved by a method for manufacturing an optical film, said method comprising the steps of providing a continuous sheet of transparent plastic material, coating one side of said sheet of transparent plastic material with a layer of curable transparent resin, embossing said coating of curable transparent resin using an embossing roller having a surface, with a predetermined surface structure, so as to provide a desired optical structure in said curable transparent resin and curing said curable transparent resin, so as to harden said desired optical structure, wherein said curable transparent resin is cured while in contact with said embossing roller.

Curing the curable resin while it is still in contact with the embossing roller minimises the creeping and flow of the curable transparent resin in general and in particular at the desired tips and bottoms, thus retaining the sharp shapes provided by the surface of the embossing roller. Furthermore, because the curable transparent resin is trapped between the embossing roller and the transparent sheet of plastic material during the curing process, the ambient air has no access.

This is in particular advantageous when, according to a preferred embodiment, said curable transparent resin is an UV curable resin, because the amount of UV initiator in the UV curable resin can be reduced. Generally, using an UV curable resin and curing it by irradiation through the sheet of transparent plastic material is desirable because it allows fast and efficient curing of the curable resin while still in contact with the embossing roller. However, most UV curable resins have a tendency of yellowing, which is generally undesired for an optical film of the kind with which this invention deals. It is primarily the initiator, which tends to produce this yellowing. The initiator, however, is sensitive to the presence of oxygen during curing. If oxygen has access, more initiator is needed. With the invention, the ambient air, and hence oxygen, has no access during the curing of the UV curable resin, and the amount of initiator and thus the tendency of yellowing can be reduced.

According to another preferred embodiment, said coating is subjected to a heat treatment prior to the embossing on the roller. Using a heat treatment decreases the viscosity of the curable resin, thus allowing degassing of the coating before the curing, so as to allow undesired gas or air enclosures, which might otherwise be trapped in the coating and affect the optical quality thereof.

According to a preferred embodiment, said heat treatment comprises infrared irradiation. Using infrared radiation from infrared heating elements for the heat treatment is easier to control, as compared to e.g. heat transfer from open flames, or heat transfer from a roller through the continuous sheet of transparent plastic material.

According to a further preferred embodiment, the continuous sheet of transparent plastic material comprises PET. PET is inexpensive, has good transparency, and is easy to subject to any surface treatment, which might be necessary for good adhesion of the curable coating.

According to yet a further embodiment, said curable transparent resin comprises unsaturated aliphatic urethane acrylate as a main constituent. A coating based on unsaturated aliphatic urethane acrylate inter alia has the advantages of good optical properties as well as good mechanical properties.

According to a preferred method, said curable transparent resin comprises a photo initiator selected from the group of α-ketones, preferably 2-hydroxy-2-methyl-1-phenyl-propan-1-one, which has good anti-yellowing properties.

According to another preferred embodiment, said curable transparent resin comprises a silicone surface additive. Using a silicone surface additive, not only allows the easier release of the cured coating from the embossing roller, and thus reduces the risk of influencing the delicate pattern or even destruction, but also aids in the degassing of the curable resin.

According to yet another embodiment, said continuous sheet of transparent plastic material has a thickness in the interval between 100 microns and 1000, preferably between 100 and 300 microns, and most preferred between 150 and 250 microns. This has been found to be sufficient for supporting the curable coating, thus keeping material costs low.

According to a particularly preferred embodiment, said curable transparent resin coating has a thickness in the interval between 100 and 1000 microns, preferably between 200 and 500 microns prior to embossment. A coating of this thickness turns out to be sufficient. With the small radii of the tips and valley bottoms, the height of the prisms need not be any higher.

For better understanding of the invention reference is made to the following detailed description of non-limiting exemplary embodiments in conjunction with the drawings, on which:

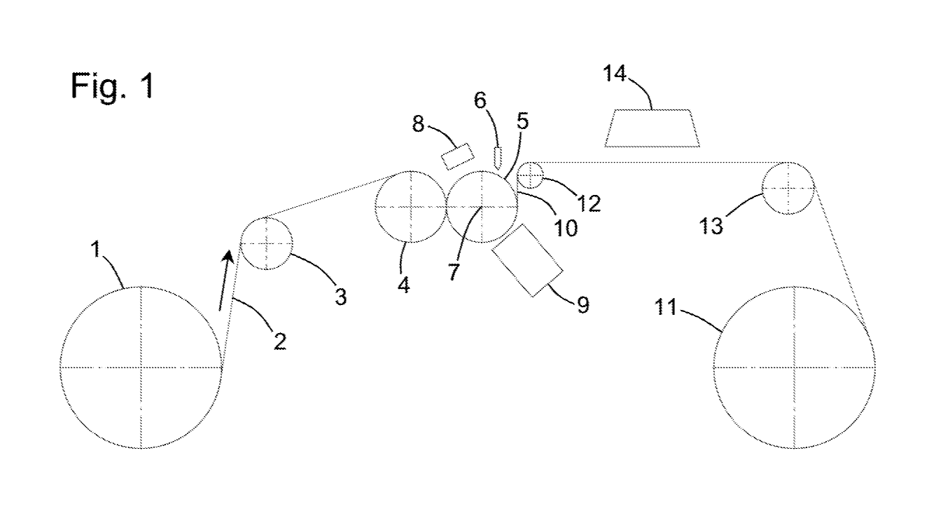

FIG. 1 schematically illustrates a machine for executing the method,

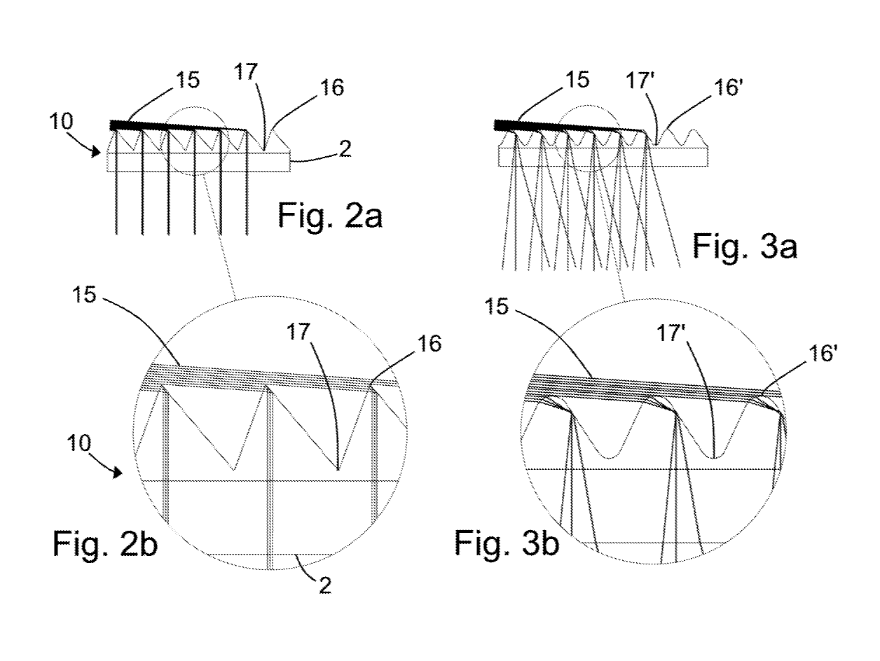

FIG. 2a schematically illustrates light rays through an optical film made by a method according to the invention,

FIG. 2b illustrates a detail of FIG. 2a,

FIG. 3a schematically illustrates light rays through a prior art optical film with large radius tips and valley bottoms, and

FIG. 3b illustrates a detail of FIG. 3a.

Starting from the left-hand side of FIG. 1, a roll 1 of a continuous sheet of transparent plastic material 2 is shown. The continuous sheet of transparent plastic material 2 is provided from the roll 1 thereof. Though the sheet of transparent plastic material 2 may be considered continuous for practical purposes, it is not infinite, and a new roll 1 will have to be brought in place when the end of a previous one is reached. The continuous sheet of transparent plastic material 2 is wound off the roll 1 in the direction illustrated with the arrow. The continuous sheet of trans-parent plastic material 2 is passed over a first roller 3, so as to control the direction and tension thereof. From the first roller, 3 the continuous sheet of transparent plastic material 2 is passed over a second roller 4. The second roller 4 may be heated in order to heat up the continuous sheet of transparent plastic material 2, or separate heating means (not shown) may be provided. This heating is optional and only serves to thermally expand the continuous sheet of transparent plastic material 2 slightly before the subsequent application of the coating, so at to compensate for any shrinkage of the coating when curing, as will be described later.

From the second roller 4, the continuous sheet of transparent plastic material 2 is lead over an embossing roller 5. The continuous sheet of transparent plastic material 2 is not itself embossed, but mainly serves as a substrate for a coating of curable resin, in which the desired three-dimensional pattern is embossed.

The coating of curable resin is delivered from a nozzle 6 of a set of nozzles spanning essentially the width of the continuous sheet of transparent plastic material 2. As can be seen from FIG. 1, the coating of curable resin is preferably not applied directly to the continuous sheet of transparent plastic material 2, but instead first to the embossing roller 5, from which it is then applied to the continuous sheet of transparent plastic material 2 when the latter is lead over the roller. As can be seen the nozzle 6 extends in parallel with the axis 7 of the embossing roller 5. It is however off-set slightly in the horizontal direction, so as not to be located directly over the axis 7 of the embossing roller 5. This means that the curable resin is applied to the embossing roller 5 and carried over the top point thereof as it rotates, the embossing roller 5 rotating counter-clockwise in FIG. 1. This aids in smoothing out the curable coating resin before it is applied to the continuous sheet of transparent plastic material 2 by the embossing roller 5. More important, however, it allows the curing resin to enter fully into the valleys between the prismatic lenses, as the resin is effectively poured into the valleys along one side thereof. If the resin was to be poured vertically into the valleys, there would be a substantial risk that air might be trapped at the valley bottoms, thus destroying the desired sharp angle at the bottom of the valleys.

At or in the vicinity of the point in the rotation of the embossing roller 5 where the curable resin is applied to the continuous sheet of transparent plastic material 2, the second roller 4 may apply a force urging the continuous sheet of transparent plastic material 2 and the coating thereon against the embossing roller 5. Depending on the viscosity of the curable resin this application of force may not be necessary and the second roller 4 may be located at a distance from the embossing roller 5.

Before the curable resin on the embossing roller 5 is applied to the continuous sheet of transparent plastic material 2, it is subjected to a heat treatment. For this it is passed in front of a heat source 8 extending essentially across the width of the continuous sheet of transparent plastic material, and at least the width of the curable resin on said continuous sheet of transparent plastic material 2, if the former does not cover the latter edge to edge. The heat source is preferably an infrared irradiation device, but could also be an open flame. The heat treatment increases the temperature of the curable resin, making the viscosity thereof decrease. The decreased viscosity of the curable resin makes it easier for bubbles of gas or air to escape, and the heat treatment thus aids in degassing the curable resin before it is cured. It also allows the curable resin to better flow all the way into the bottom of the valleys. Both of these are important because any bubbles trapped in the curable resin after it has been cured will permanently affect the optical properties, e.g. by giving rise to undesired reflections and refractions of light rays within the prismatic lenses on at the external surfaces thereof.

As the embossing roller 5 rotates, the curable resin, forming now a continuous curable coating sandwiched between the continuous sheet of plastic material 2 and the surface of the embossing roller 5, is passed in front of an UV irradiation device 9. Like the nozzle 6 and the heating device 8 it extends essentially across the width of the continuous sheet of transparent plastic material 2.

Here it should be noted that it might be preferable not to provide the coating of curable resin all the way to the edges of the continuous sheet of transparent plastic material 2, in order to reduce access of ambient air during curing. If not cured properly due to access of oxygen, the coating may stay tacky at the edges, which is undesired further in the process or during storing. The excess of transparent material will engage the embossing roller 5 during curing of the resin, thus effectively sealing the curable resin off from the oxygen in the ambient air. It may also be possible to add further light sources at the edges, preferably irradiation with different frequencies, in order to secure full curing at the edges.

After curing, the optical film 11 formed from the continuous sheet of transparent material 2 and the cured embossed resin coating, is peeled of the embossing roller 5, and wound to the roll 11. Evidently, rolling the optical film 10 to a roll 11 is only an example of storage. As an alternative to rolling the optical film 10 for storage, direct post processing of the optical film 10 is of course also possible, e.g. by cutting it into appropriately sized sheets. Alternatively, it is in this post processing possible to cut away the edges of the optical film, rather than taking the precautions mentioned above regarding the edges.

During post processing or before winding the resulting optical film on a roll 11, the optical film 10 may be lead over additional rollers 10 and 11. Any number of rollers can be used in order to lead the optical film 10 to the roll 11 for storage, depending on the path and distance to the roll 11. Here the rollers 12 and 13 are illustrated because they provide a path in front of a further heating device 14. This further heating device 13 is preferably also an IR irradiation device. The further heating device 14 heats the entire optical film 10 in an annealing process to remove internal tensions and stress deriving from e.g. the curing of the curable resin, which might influence the optical properties of the optical film 10 adversely. As mentioned above, such stresses may occur due to the curable resin shrinking during curing, even though it may to some extent be countered if the continuous sheet of transparent plastic material 2 is heated prior to the application of the curable resin, allowing it to subsequently contract thermally with an amount corresponding to the shrinkage of the curable resin.

Regarding the post processing it should be noted that having a fully cured optical film 10 with a surface structure on one side of the sheet of transparent of plastic material 2, it would also be possible to provide the other surface of sheet of the transparent plastic material 2. This would inter alia allow for an optical film 10 reflecting light, albeit not necessarily with imaging. Coating the other surface of the optical film 10 would involve the same method, i.e. coating the other side of said optical film 10 with a layer of curable transparent resin, embossing said coating of curable transparent resin using a further embossing roller (not shown) having a surface, with a predetermined surface structure, so as to provide a desired optical structure in said curable transparent resin and curing said curable transparent resin, so as to harden said desired optical structure, while said curable transparent resin in contact with said further embossing roller.

Though the above process can be used with many combinations of materials for forming the optical film 10, the best mode of manufacturing the optical film 10 is based on the use of a continuous sheet of transparent PET. PET has good adhesive properties and with an appropriate choice of curable resin no surface treatment is necessary for securing good adhesion thereof. For the curable a resin, a resin comprising unsaturated aliphatic urethane acrylate, mixed with a photo initiator comprising an α-ketone, preferably 2-hydroxy-2-methyl-1-phenyl-propan-1-one, and a silicone surface additive, such as a polyether modified dimethylsiloxane copolymer to provide good wetting of the PET.

More specifically a combination of Desmolux™ 2308 and Desmolux™ 2513, (available from Bayer MaterialScience LLC, 100 Bayer Road, Pittsburgh, Pa. 15205-9741, USA) mixed with Ciba® Darocur® 1173, (available from Ciba Specialty Chemicals Inc, CH-4002 Basel, Switzerland), and BYK 333 (available from BYK USA Inc., 524 South Chemy Street, P.O. Box 5670, Wallingford, Conn. 06492, USA).

The exact composition of the curable resin will depend on the actual surface structure to be achieved. Desmolux™ 2513 increases the flexibility of the optical film 10 whereas Desmolux™ 2308 makes it harder but more prone to cracking when peeling the optical film off the embossing roller 5. Thus with very steep and narrow structures, an increased amount of Desmolux™ 2513 would be preferable. Similarly, the amount of surface additive needed will also be higher with steep and narrow structures. It may in some cases even be omitted. The amount of photo initiator will depend on the overall thickness of the curable coating of the optical film 10.

For practical purposes the following compositions have been found to yield good properties:
30%-70% by weight of Desmolux™ 2308
30%-70% by weight of Desmolux™ 2513
1%-5% by weight of Ciba® Daroccur® 1173
0%-0.5% by weight of BYK 333
   Based on the currently performed tests the following specific composition has proved itself very useful for a range of surface structures:
48.4% by weight of Desmolux™ 2308
48.4% by weight of Desmolux™ 2513
2.91% by weight of Ciba® Darocur® 1173
0.29% by weight of BYK 333
   The curable resin composition was coated onto Toyobo A4300 PET films of thicknesses of 188 microns and 250 microns in thicknesses of approximately 200 microns, at a resin temperature of approximately 70° C. and embossed to a depth of approximately 180 microns, and a pitch, i.e. the distance between adjacent prisms, of approximately 40 microns. The radius of the resulting tips 16 and valley bottoms 17 were found to be in the interval of 1 to 2 microns.

Further experiments have shown that a coating of up to 1 mm on top of a film of up to 300 microns or even 1000 microns yields satisfactory results.

FIG. 2a schematically illustrates a beam of light illustrated as twelve rays 15 propagating through a simple exemplary prism structure of an optical film 10, as it could be made with a method according to the invention. The prisms have tips 16 and valleys 17 between adjacent prisms. As can be seen, the light rays propagate in parallel through the optical structure and emerge in parallel, even though entering the structure close to the tip of the prisms. This can be seen more in detail in FIG. 2b. As can be seen by comparison with FIG. 3a and FIG. 3b, this would not be the case if, as was the case in the prior art, the radius of the tips 16′ and valley bottoms 17′ is larger. Here the twelve light rays 15 are scattered in different directions.

As to the embossing roller 5 it should of course be noted that it has to have an equally fine structure. Preferably, these are cut in a brass surface of the embossing roller 5 using a diamond cutter, but a surface comprising amorphous electrolytic nickel has also been contemplated. Experiments have shown that with the fine details achievable with the overall method, special care has to be taken in cutting the surface of the embossing roller 5. If the quality of the cutting diamond is insufficient, the surfaces of the prisms will have too many imperfections. In fact it has turned out that industrial grade diamonds cannot be used, but mono crystalline diamonds are necessary for this cutting. As an alternative to diamond cutting, machining using focussed plasma or laser could be used.

The above description has been given as an example only and should not be considered restricting the scope of the protection as defined by the claims. Rather the skilled person will know that numerous alternatives and modifications to the method are possible without deviating form the scope of the invention.

1. Method for manufacturing an optical film, said method comprising the steps of
providing a continuous sheet of transparent plastic material,
coating one side of said sheet of transparent plastic material with a coating comprising a layer of curable transparent resin,
embossing said coating of curable transparent resin using an embossing roller having a surface, with a predetermined surface structure, so as to provide a desired optical structure in said curable transparent resin
curing said curable transparent resin, so as to harden said desired optical structure,
wherein said curable transparent resin is cured while in contact with said embossing roller.

2. Method according to claim 1, wherein said curable transparent resin is an UV curable resin.

3. Method according to claim 1, wherein said coating is subjected to a heat treatment prior to the embossing on the roller.

4. Method according to claim 3, wherein said heat treatment comprises infrared irradiation.

5. Method according to claim 1, wherein said continuous sheet comprises PET.

6. Method according to claim 1, wherein said curable transparent resin comprises unsaturated aliphatic urethane acrylate as a main constituent.

7. Method according to claim 2 or claim 3 wherein said curable transparent resin comprises a photo initiator selected from the group of α-ketones.

8. Method according to claim 2 or claim 3 wherein said curable transparent resin comprises a silicone surface additive.

9. Method according to claim 1 wherein said continuous sheet of transparent material has a thickness in the interval between 100 and 1000 microns, preferably 100 microns and 300 microns, and most preferred between 150 and 250 microns.

10. Method according to claim 1, wherein said curable transparent resin coating has a thickness in the interval between 100 and 1000 microns, preferably between 200 and 500 microns prior to embossment.

11. Optical film manufactured using a method according to claim 1.
